(19) United States
(12) Patent Application Publication
(10) Pub. No.: US 2013/0346134 A1
(43) Pub. Date: Dec. 26, 2013

(54) SYSTEM AND METHOD FOR COORDINATING AND CONTROLLING PRODUCTION PROCESSES AND INTER-RELATED DECISION MAKING PROCESS

(71) Applicants: Karl Klug, Miesbach (DE); Jurgen Totzke, Poing (DE)

(72) Inventors: Karl Klug, Miesbach (DE); Jurgen Totzke, Poing (DE)

(73) Assignee: SIEMENS ENTERPRISE COMMUNICATIONS GMBH & CO. KG, Munchen (DE)

(21) Appl. No.: 13/980,964

(22) PCT Filed: Feb. 24, 2012
(86) PCT No.: PCT/EP12/00816

§ 371 Date: Jul. 22, 2013

(30) Foreign Application Priority Data
Feb. 25, 2011 (EP) 11001583.1

(51) Int. Cl. G06Q 10/06

(52) U.S. Cl. CPC G06Q 10/063114
USPC 705/7.15

(57) ABSTRACT

A communication system is provided that includes a plurality of communication devices and a plurality of servers. The servers are communicatively coupled to the communication device and each server hosts a service accessible by the communication devices. One of the servers or at least one of the communication devices may communicate with at least one of the servers and the communication device to monitor communication events related to a project defined for monitoring by user input provided for creating the project for purposes of monitoring the project.

### CROSS-REFERENCE TO RELATED APPLICATION

The present application claims priority to European Provisional Patent Application No. 11 001 583.1, which was filed on Feb. 25, 2011. The entirety of European Provisional Patent Application No. 11 001 583.1 is incorporated by reference herein.

### FIELD OF INVENTION

The present invention relates to communication systems and methods of using such systems. Embodiments of the invention may include computer systems and methods of using such systems that monitors projects and communication events associated with those projects. Embodiments of the system and method may also include registering and documenting persons working on a particular project or involved in a particular event associated with the project.

### BACKGROUND OF THE INVENTION

Currently known approaches for providing communications within a corporate structure include systems based upon Business Process Management (“BPM”) or Human Interaction Management (“HIM”) methodologies. Systems built on such methodologies usually attempt to achieve flexibility by means of a case based business process paths as an alternative to continuous business process paths. Different processes can therefore be triggered by additional business event assessments.

For instance, an event can be triggered by the aggregation of many smaller events via Complex Event Process (“CEP”) components utilized in accordance with BPM methodologies. The use of CEP components, however, often results in an approach at identifying and resolving events in an overly limited basis. For example, distinction of types of events must be known when the process is designed for a corporation since automated business processes cannot be provided in real time.

Approaches utilizing HIM methodologies usually are employed in the field of messaging. Such approaches therefore often fail to account for the fact that the primary human communication media is speech, facial expressions and gestures. The use of such approaches therefore fails to often account for substantial information that may be utilized.

Based on available estimates, routine business transactions typically contributes by as much as 80% of value creation and usually requires about 20% of working time by employees of a business. The remaining 20% of value creation, however, requires about 80% of the working time spent by the employees. Such working time usually relates to tasks that must be performed by persons having knowledge of the transaction or having management responsibilities. As a result, such work is often interrupted due to unexpected events or non-routine processes that may arise that those workers must address in addition to performing their other work. Due to the interruption of processing the routine work matters, some work matters may be dropped or forgotten while others are less efficiently performed. In fact, as much as 30% of interrupted business transactions have been observed as being forgotten or otherwise dropped as a result of the transaction being interrupted due to other events or occurrences that affect one or more workers involved in the transaction.

A new system and method of using such a system are needed to provide a system by which business events may be better anticipated and resolving such events may be more efficiently addressed. Preferably, such a system and method utilize and are compatible with hardware elements and applications already being customarily used by businesses.

### SUMMARY OF THE INVENTION

A communication system is provided that includes a plurality of communication devices and a plurality of servers. The servers are communicatively coupled to the communication device and each server hosts a service accessible by the communication devices. One of the servers or at least one of the communication devices may communicate with at least one of the servers and the communication device to monitor communication events related to a project defined for monitoring by user input provided for creating the project for purposes of monitoring the project.

Each of the communication devices may be a computer, laptop, telephone, IP telephone, cellular phone, tablet, smart phone, or other type of endpoint directly used by a user to communicate to another person utilizing a communication system such as, for example, a data network or phone network. Each of the servers may be a computer device having at least one processor unit and memory that are configured to host a service available to the communication devices utilizing a network connection or other connection.

In some embodiments of the system, at least one of the communication devices may be configured to display indicia identifying an estimate for a degree of completion of the project and may also display indicia identifying users associated with a project.

Some embodiments of the system may utilize other network elements such as one or more gateways that couple communication devices or one or more servers to a network. The one or more gateways could include one or more routers, at least one switch, at least one base station or at least one access point, for example.

The system may be configured so that at least one of the communication devices communicates with at least one of the services to monitor communication events related to the project. Alternatively, one of the servers may communicate with other servers and other communication devices to monitor the project. The project may be monitored so that messages are periodically sent to the communication devices, the servers, or both the servers and the communication devices to prompt receipt of data related to completion of the project. The monitoring of the project may take place so that work on the project is autonomously documented and stored by a communication device or server performing the monitoring.

A method for monitoring the work on at least one project is also provided. The method includes the communication devices communication with servers that each host at least one service. One of the severs or at least one of the communication devices monitor work done to complete the project by communicating with at least one server and at least some of the communication devices to monitor the work done to complete the project. Data may be provided such that user indicia based on the data is displayable that identifies a degree to which a monitored project is completed upon receipt of user input for assessing the project.

Messages may be periodically sent to communication devices, servers, or both to prompt receipt of data related to completion of the project. The data may also provide data used to create user indicia that identifies users associated with the project.

Data related to the project may be updated to account for changes in progress related to events, genres, and genre subtasks associated with the project so that the updated data is providable for inclusion in the data provided so that user indicia based on the data is displayable to identify a degree to which the project is completed.

A communication device is also provided. The communication device includes a processor, non-transitory memory, a transceiver unit, and a display unit. The processor may be coupled to the memory, transceiver unit and the display unit. An application may be stored on the memory that is executable by the processor so that when the application is executed the communication device communicates with at least one of servers and other communication devices to monitor work done to complete a project by communication with the servers and communication devices to monitor the work done to complete the project. The display unit may display user indicia based on data obtained from the monitoring of the project that identifies a degree to which the project is completed. In some embodiments, the user indicia may also include indicia identifying users associated with the project.

The communication device may also be configured so that a message identifying users associated with a communication event of the project is automatically created upon received user input identifying a communication event of the project to initiate. The message may identify addresses as the users associated with the communication event based on those users being predefined as being associated with the communication event.

A method for monitoring work on at least one project comprising different predetermined necessary events, genres and genre subtasks is also provided. The events may comprise at least one of: Clarification of Technical Details, Task Coordination, and Coordination of Communication and the genres comprise at least one of: Situational Real-Time Planning, Ad-hoc Collaboration, and Multi-channel Communication. The method may include the step of a plurality of communication devices communicating with a plurality of servers. Each server hosts at least one service accessible to the communication devices. The plurality of servers comprises at least one of: a messaging server that hosts text messaging, a teleconference server that hosts and oversees teleconferencing communications, a telecommunications server that hosts or otherwise supports telephone calls, a server comprising a database such as document database, an electronic mail server hosting electronic mail services for different users, a context server communicating with network elements to assess the types of calls or other communications being received or made by the communication devices. The network elements comprise at least one of a business intelligence system, one or more switches, one or more private branch exchanges, Internet applications and office application software that is provided by one or more of the servers. The method also includes the step of a presence server monitoring the presence of different users by interacting with other servers such as the electronic mail server, teleconference server, telecommunications server, messaging server, and context server and by communicating with the communication devices. One of the servers or at least one of the communication devices monitors work done to complete a project by communicating with at least one of the servers and at least some of the communication devices to monitor the work done to complete the project in that messages are sent to the communication devices, the servers, or both the servers and the communication devices to prompt receipt of data related to completion of the project. The one of the servers or at least one of the communication devices provide data such that user indicia based on the data is displayable that identifies a degree to which the project is completed upon receipt of user input for assessing the project, the user indicia comprising contact information for each user.

In some embodiments of the method, the step of communicating with at least one of the servers and at least some of the communication devices to monitor the work done to complete the project may include that the data comprises data for use in displaying at least one link for obtaining a view or copy of documents generated for completion of one of the events, genres and genre subtasks. Each link may be configured so that upon actuation of the link an approval document is downloaded or viewable from a communication device or other device used to access that link via communication with the device that has the memory in which the generated document is stored.

Some embodiments of the method may be implemented so that the step of communicating with at least one of the servers and at least some of the communication devices to monitor the work done to complete the project further comprises sending of an electronic message such as a text message, electronic mail document, calendar event communication, or teleconference message and the saving of a document in the database or document storage system maintained by one of the servers for identification that a task has been completed.

A communication device of a user is also provided. The communication device comprises a memory whereon with respect to a search phrase a list, being ordered in a predetermined sequence, of media is stored for establishing a communication connection to a communication participant such that at least one of the media is assigned a point in time at which the user receives a hint to the least one of the media for establishing a communication connection to the communication participant by the communication device using the to the least one of the media.

In some embodiments, the communication device has an interface to an Identity and Access Management System for gathering information about Contextual Communication. In addition, or in the alternative, the communication device and/or the server may have an interface to Business Software. In one embodiment, the communication device has an interface to Business Software.

In one embodiment of the communication device, the information is visible only to the user generating the list or causing the list to be generated occurs when the list related to each medium information is stored related to the communication context of the medium. Also, or in the alternative, embodiments of the communication device may have an interface to location-based services for providing location information or location dependent information to one or several of the media of the list.

A communication system is also provided. The system may include a communication device of a user and a server coupled to the communication device. On the server with respect to a search phrase, a list, being ordered in a predetermined sequence, of media is stored for establishing a communication connection to a communication participant such that at least one of the media is assigned a point in time at which the user receives a hint to the least one of the media for establishing a communication connection to the communication participant by the communication device using the to the least one of the media.

The communication system may be configured so that the communication device and/or the server have/has an interface to an Identity and Access Management System for gathering information about Contextual Communication.

In the list related to each medium information is stored related to the communication context of the medium, the information may only be visible to the user generating the list in some embodiments of the system. The communication system may also, or alternatively, be configured so that the communication device and/or the server has an interface to location-based services for providing location information or location dependent information to one or several of the media of the list.

Other details, objects, and advantages of the invention will become apparent as the following description of certain present preferred embodiments thereof and certain present preferred methods of practicing the same proceeds.

### BRIEF DESCRIPTION OF THE DRAWINGS

Present preferred devices, systems, and apparatuses for registering and documenting business events are shown in the accompanying drawings and certain present preferred methods of practicing the same are also illustrated therein. It should be understood that like reference numbers used in the drawings may identify like components.

FIG. 1 is block diagram of an exemplary embodiment of a computer system, or communications system.

FIG. 2 is a list illustrating different event options that may be shown or displayed to a user for selecting as being appropriate events for a particular project or business matter that is usable in embodiments of the computer system.

FIG. 3 is list illustrating different genres or type of event options that may be shown or displayed to a user for selecting as being appropriate for a particular project or business matter that is usable in embodiments of the computer system.

FIG. 4 is a flow chart illustrating an exemplary method of selecting events and genres to monitor for a particular project that may be utilized in embodiments of the communication system.

FIG. 5 is a flow chart illustrating an exemplary organizational structure on which an embodiment of the system may be developed.

FIG. 6 is a block diagram illustrating an exemplary display of indicia that may be used for displaying a user indicia identifying parameters related to work being performed to complete a project.

### DETAILED DESCRIPTION OF PRESENT PREFERRED EMBODIMENTS

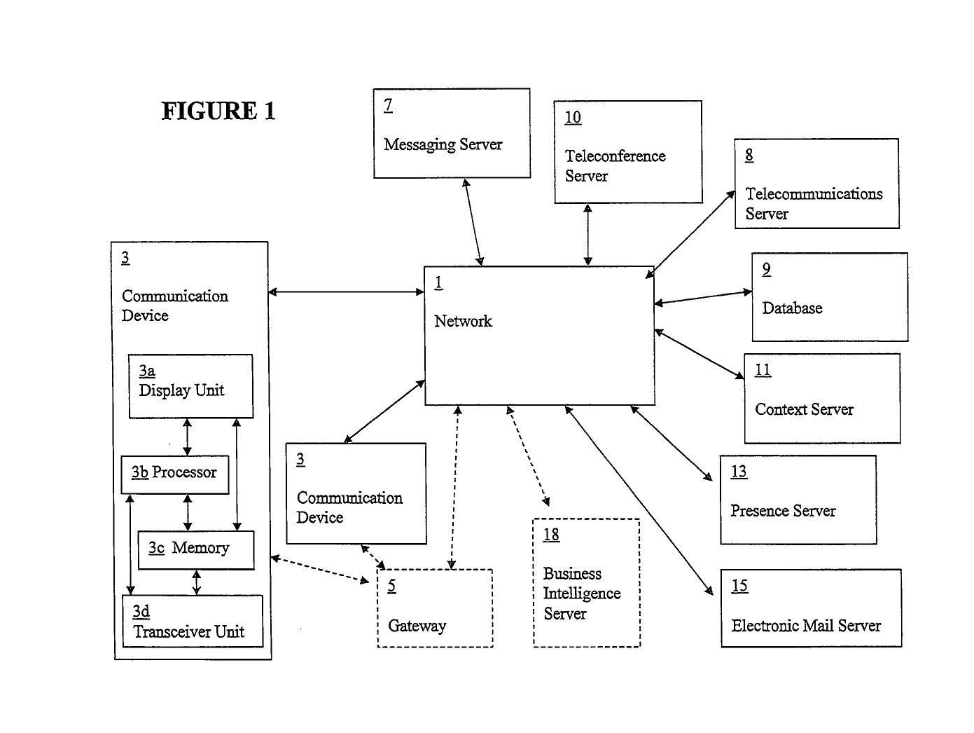

Referring to FIG. 1, embodiments of the system may include a network 1 that includes a plurality of communication devices 3. Each of the communication devices 3 may be any of a number of different terminal communication devices such as a computer, laptop, mobile phone, smart phone, tablet, workstation, telephone, IP telephone, endpoint, or other type of client device. Each communication device may include a display unit 3a that is used to display information to a user. The display unit may include a touch screen, liquid crystal display, monitor, or other display element. The communication device may also include a processor 3b, non transitory memory 3c and a transceiver unit 3d. The transceiver unit 3d may include one or more receiver units and one or more transmission units. The transceiver unit 3d may be configured for communications via at least one wireless or at least one wired link. The processor 3b may include one or more interconnected processors, controllers, microchip processors, or processor units. The non-transitory memory may be a computer readable medium. The processor may be configured to execute programs or applications stored in the memory or that are otherwise accessible to the communication device via a network connection. The communication devices 3 may also be connected to peripheral devices such as microphones, speakers, keyboards, cameras, other input devices, or other output devices.

Each communication device may communicate via a network by a network connection. Such a network connection may utilize a node of the network. For instance, some communication devices may communicate with a gateway 5, which is illustrated in dotted line in FIG. 1, to communicate with other network elements of the network 1. For instance, communication devices may communicate with at least one base station, at least one access point, at least one router, or other types of gateways. Other communication devices may directly form a network connection via the transceiver unit of that device.

The network 1 may include a plurality of servers or other types of computer devices that host a service. Each server may include at least one processor unit that is communicatively coupled to at least one transceiver unit and non-transitory memory that has at least one application stored thereon configured so that the server may host the service. For example, the network 1 may include a messaging server 7 that hosts text messaging via the network 1, a teleconference server 10 that hosts and oversees teleconferencing communications, telecommunications server 8 that hosts or otherwise supports telephone calls, and one or more databases 9, such as document databases. Additionally, the network may include a context server 11, a presence server 13 and an electronic mail server 15. The electronic mail server may host electronic mail services for different users. The presence server 13 may monitor the presence of different users by interacting with other servers such as the electronic mail server, teleconference server, telecommunications server, messaging server, and context server and by communicating with different communication devices. The context server 11 may be an element of an identification and access management system or may host functionality of such a system. The context server 11 may communicate with different network elements of the network to assess the types of calls or communications being received or made by different communication devices within the system. Network elements that are included in the system may also include a business intelligence system, one or more switches, one or more private branch exchanges, internet applications and office application software that is provided by one or more servers. In some embodiments, the telecommunication server 8 may be a private branch exchange.

Embodiments of systems may be configured to utilize other communication network elements typically found in enterprise networks and other types of networks. Examples of systems having such network elements may be found in U.S. Pat. No. 7,583,965 and U.S. Patent Application Publication No. 2009/0013085. The entirety of U.S. Pat. No. 7,583,965 and U.S. Patent Application Publication No. 2009/0013085 is incorporated herein by reference.

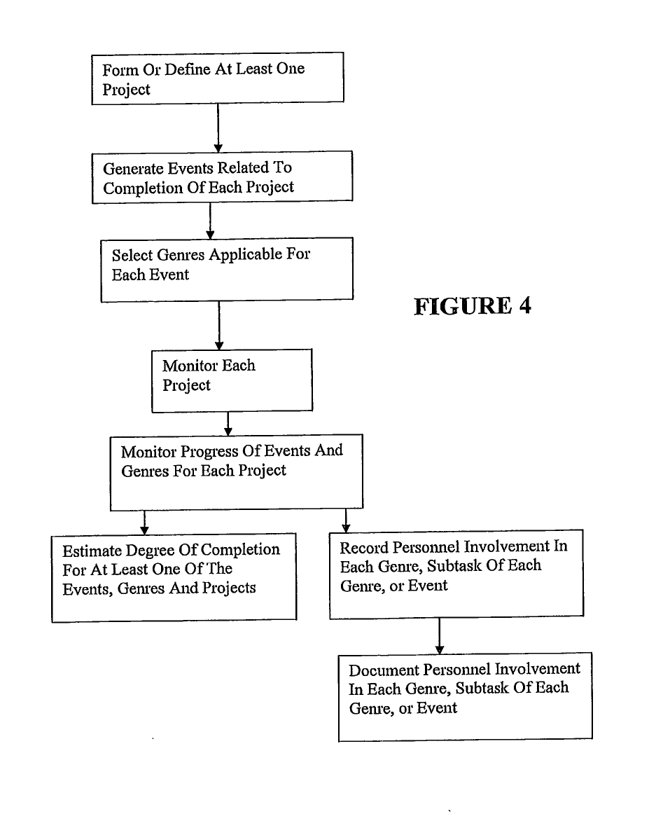

The communication device 3 includes an application stored in memory 3c of the communication device 3. A user may actuate the application by providing input the communication device so that the application starts to run upon providing this user input. The communication device 3 may display a user interface via the display unit 3a to permit a user to visually track different projects and the progress of those projects. Additionally, a user may create a new project to be monitored by providing input to the communication device 3. The communication device may be configured for implementing a method, such as an exemplary method illustrated in FIG. 4.

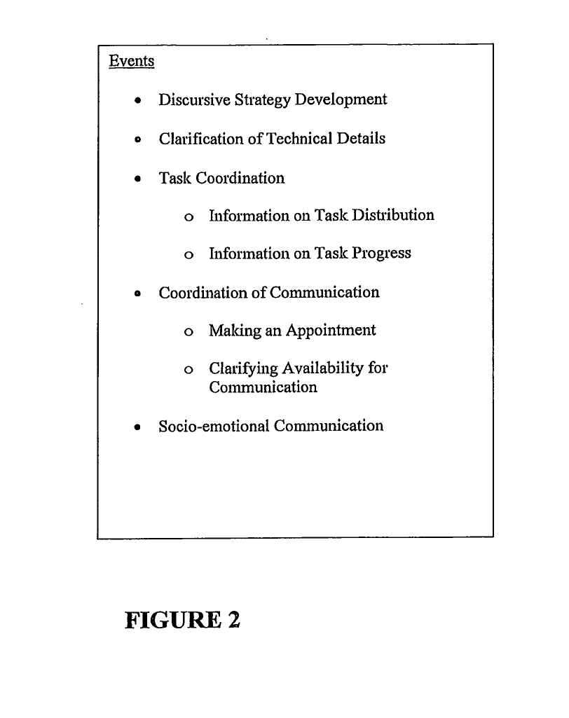

The communication device 3 may display a number of options to the user upon the user providing input to create a new project to be monitored. The options may include a number of event options to define steps need to be completed to finish the project. In some embodiments, the event options may be pre-populated based upon input from a user identifying a project as corresponding to a predefined model project having events listed therein. Alternatively, a user may provide input for identifying events that are to correspond to the implementation and completion of a project. Those events may include communication events, as may be appreciated from FIG. 2. Upon selecting an event to include as a necessary step for completing a project, that event may be saved and documented as corresponding with the new project and the completion and steps taken to complete the project may subsequently be monitored.

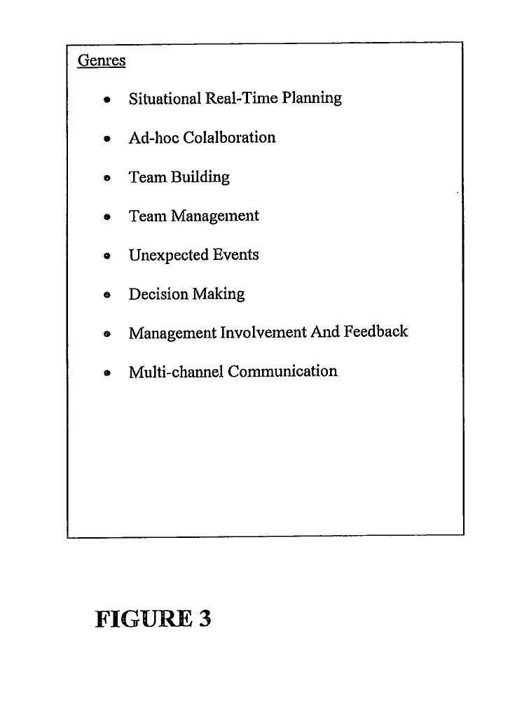

Additionally, the communication device 3 may display a new set of options that may be provided to a user for selecting one or more genres as corresponding to the new event as may be appreciated from FIG. 3. The one or more genres may be found to include subtasks needed to complete the genre. The subtasks and genres may be pre-populated upon the creation of a project based upon user input that identifies a model on which the project is to follow. In addition, or as an alternative, the subtasks and genres may be selectable from a list of predefined options. In some embodiments, the genres may be selectable, but the subtasks may be configured to populate automatically upon selection of a particular genre. It should be appreciated that the genre subtasks may include the use of a particular type of media (e.g. speech by phone, teleconference, application sharing, video, instant messaging, etc.). A user may provide input for selecting one or more needed subtasks that can be performed to complete a genre utilized for completing an event and those selected subtasks may be recorded and progress in completing each selected genre and subtask associated with each genre may be subsequently monitored.

The genres for a given event and subtasks associated with each genre may be modeled or prespecified for different projects. For example, a project associated with completion of a contract may be defined as including different predetermined necessary events, genres and genre subtasks. Upon selecting such a predefined project, user input related to user responsibilities may be the lone further input needed for the server to monitor a particular project. Of course, other embodiments may have the users responsible or to be included in such matters also predefined so that such information also is not needed for manual input prior to a project being monitored. Of course, such selected projects may also be manually updated by the communication device 3 receiving user input selecting additional events, genres or genre subtasks for a particular project to include the selected additional events, genres, or genre subtasks to permit user customization for monitoring and documenting activities related to the completion of a particular project.

Users may be associated with a project and different users may be assigned as being responsible for completion of a particular event or for inclusion in a particular genre. Further, any communication genre that is selected for inclusion in a project may result in the generation of one or more subtasks that are associated with one or more users that are to be included in the subtask or be responsible for completion of that subtask.

For instance, selection of a project for forming and completing a contract with a vendor may include a number of events that include different users responsible for overseeing or completing genres or tasks associated with those events. One event may be negotiation of business parameters for a contract and a second event may be approval of the contract. The negotiation of the business parameters may be assigned to a first user that is a business unit manager. The approval of the contract event, however, may be assigned to a second user who is an attorney of the business. Those users may be identified as responsible for the different events. It should be appreciated that the selection of a genre or selection of genre subtasks can be assigned to different users in the same way events may be assigned.

In some embodiments, the communication device 3 may communicate with a business intelligence server 18, which is shown in dotted line in FIG. 1, to have that server collect information related to the progress made to achieve an objective or to complete a project, event, or genre. The business intelligence server 18 may also communicate with other network elements to perform the monitoring of the projects, events, genres, and genre subtasks and update information related to the progress and implementation of such matters upon receiving data from a communication device that such projects, events, genres, or genre subtasks have been created for monitoring. The communication device 3, servers and other network elements, for example, may provide information to update the business intelligence server 18 with data related to such information. Such information may be provided periodically to the business intelligence server 18 or may be made upon receipt of a message from the business intelligence server 18 prompting the network elements to provide such data to the business intelligence server 18. In some embodiments, the business intelligence server 18 may be configured to implement all or some of the steps of the method illustrated in FIG. 4.

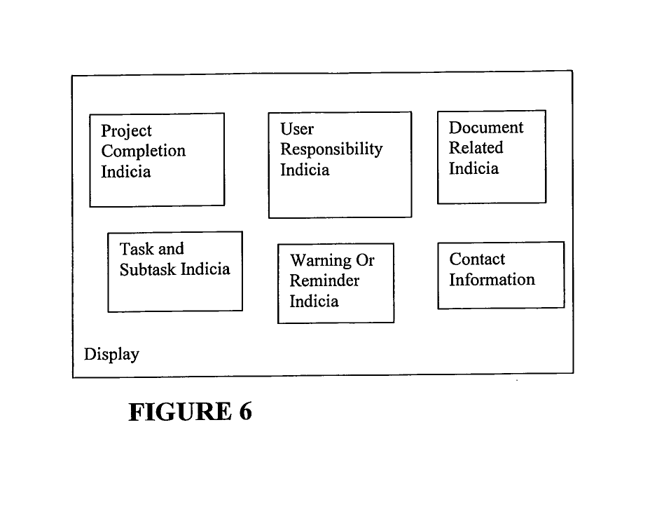

The different projects and related project matters (e.g. events, genres, and genre subtasks) are monitored such that when the communication device 3 utilizes the application for a user to assess the progress of a particular matter, the communication device 3 communicates with the business intelligence server 18 to obtain information about a selected project, event, or genre or genre subtask so indicia related to the work done on the selected project may be displayed to a user via a display unit of the communication device 3. As may be appreciated from FIG. 6, that information may include data used to display an indication of the degree or extent to which a particular matter is completed and the identification of the previous activities undertaken to complete the matter. Data may also include data for use in displaying links for obtaining a view or copy of documents generated for completion of a particular subtask, genre or event may also be displayed. Use of an input device of the communication device to actuate a displayed link may result in the document being displayed to a user via a display unit. Additionally, data for providing a display of indicia related to the users associated with a particular matter may also be shown or provided within that information. The user indicia may include, for example, contact information for each user such as a phone number or email address for that user.

The indication that provides an estimate of the degree to which a particular subtask, genre, event or project is completed may be estimated based upon the degree of completion of a required set of tasks associated with completion of that matter. A user's estimated degree of completion with a task or subtask assigned to that user may also be estimated based on which matters related to a particular task was completed or has yet to be completed by a user.

The system may also be configured to generate and communicate warnings to a user related to completion of a particular project, event, genre, or genre subtask. For example, the communication device or business intelligence server 18 may be configured to monitor task completion. If certain tasks are not completed within a predetermined time period, a warning may be generated and sent to a device associated with a user for communicating the lack of completion of a particular matter to that user or to serve as a reminder that a particular matter should be completed by a certain deadline defined by the predetermined amount of time. Such a warning may be a text message, email, calendar event, or voice mail, or other communication or message that provides such information to a user.

When a monitored genre subtask, genre, event, or project is completed, the system may be configured to register the completion of that matter and document all persons and roles involved while working on that matter. Such information may be obtained from queries or information obtained during the monitoring of the matter by the communication device or server that performs the monitoring. A document certifying project completion as well as a project report of tasks performed and completion dates for those tasks may be generated and saved so that a record is retrievable related to the completed project at a later time. Project reports indicating that a project is not yet complete may also be provided that identify tasks and when those tasks were complete and also identify tasks that have not yet been complete and who is responsible for the completion of such tasks. Such a document may be stored in a database or memory of a server or other computer device and may also be printed out after being generated for storage in a physical, hard copy format.

A user may also review and rate the completed project for purposes of providing a record of assessment of the timeliness, proficiency and excellence of the completed project, event, genre, or genre subtask. Such review information may be stored as a separate document associated with the generated record or may be stored within the generated record. The information may be utilized in a database or be retrievable by a server from where the record is stored for use in assessing the performance of different users or the effectiveness of different events, genres, or genre subtask predefined organizational models used for different types of projects, events, genres, etc., or such information may be used to develop such organizational models for defining predetermined organizational models for particular project types or different events, genres, or genre subtasks.

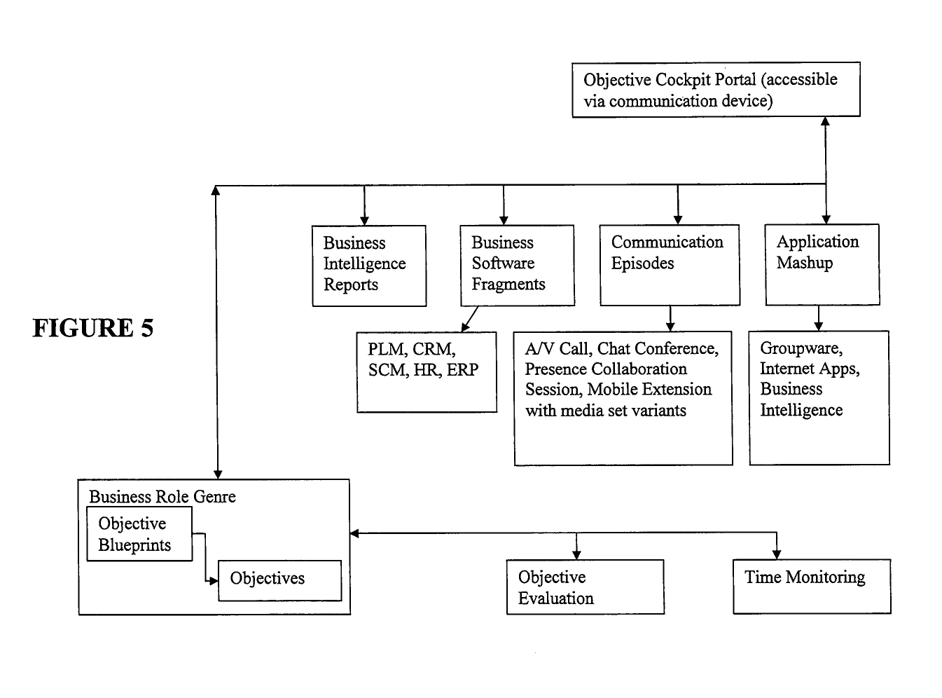

It should be appreciated that embodiments of the system and methods of using the same discussed above are exemplary. For instance, any system or communication device may be alternatively configured to implement the organizational structure and methodology illustrated in FIG. 5 for purposes of designing alternative embodiments of systems.

It should be understood that embodiments of the system may be configured to integrate situational business process fragments of a preexisting IT system in the context of communication and information genres. The system may be configured to focus on, monitor, and record human interaction for employees based on their use of speech and supportive media to integrate into the execution of at least partially defined routine processes used for completing different tasks as soon as requirements corresponding to such required interactions have been met.

Corporate communication is often based on a variety of communication genres that may form a recurring pattern. Such patterns, however, often have to be adjusted to a concrete business transaction or project. An individual's communication genres and role within an organization also help define a business context in the business environment. Sequentially spaced apart communication events typically define the work toward completion of a particular project. The arrangement of the events can be flexibly determined in a result oriented manner by a person or device that controls the genre. Embodiments of the system may be configured to provide a number of available events to provide collaboration for a particular business environment to accommodate the users assigned to the event and the roles of the persons in the scheme of completing the project.

Embodiments of the system are preferably configured so that the chronological progress of a result oriented process is monitored by correspondingly monitoring and tagging intermediate results defined by selected events, genres and genre subtasks. The system is also configured so that the work on and completion of such matters are documented. A predetermination of preferred ways in which a project, event or genre is addressed may also be defined as a best practice so a user setting up a new project develops a process based on such best practices that can then also be monitored by the system.

In one embodiment of the system, a user may utilize the system by accessing a server hosting the project monitoring service 18 via a communication device 3. The communication device may be configured to display a user interface that permits a user to provide input to the communication device 3 that is subsequently sent to the server 18 for providing that input to the server 18. The communication device 3 may be used to provide input for creating a project to be monitored by the server 18, for example. After a project is created and different events, genres, genre subtasks and other tasks related to the completion of the project is created, the business intelligence server 18 may monitor the progress made toward completing the different tasks for the formed project.

For instance, if a project is created for developing a new product design, the project may include a number of communication events such as (a) a meeting to assess the goal and objectives for the new design, (b) a conference call for assessing possible design options, (c) receiving approval from a research and development manager approving the new design and (d) receiving approval from a marketing manager that approves the new design and (e) a meeting with a safety manager that confirms the new deign is appropriately safe. Each of these five events a-e may then be monitored by the business intelligence server communicating with the communication devices associated with the users assigned to perform or be involved with each of these five tasks as well as communicating with the database 9, presence server 13, and other servers of the system for monitoring completion of different subtasks associated with each of tasks a-e. For instance, communications with the teleconference server 10 may provide data to the business intelligence server 18 that shows that the meeting to assess the goal and objectives of the new design was held and, in response to receipt of such data, the business intelligence server may update its records to show that the meeting was held, which parties or users attended the meeting and where the meeting was held at for purposes of documenting that event and indicating that the task of task a was completed. Thereafter, the business intelligence server may receive a message in response to a prompt from the database 9 showing that a design drawing was prepared for purposes of updating its records for the project. The business intelligence server 18 may also learn of the approval of a particular design drawing via monitoring of the electronic mail server 15 or database 9 and upon receipt of data indicating this approval was granted. A link to the approval document may be created and stored by the business intelligence server in the records created to document this approval as well as to document who provided the approval and when the approval was given. The link may be configured so that upon actuation of the link the approval document is downloaded or viewable from a communication device or other device used to access that link via communication with the device that has the memory in which the generated document is stored.

The monitoring and documenting for the project may occur autonomously by the business intelligence server 18 monitoring the project and periodically communicating with the different network elements that may be utilized for completion of a particular subtask or completion of a particular communication based task associated with the project. When the last task of the project is found to be completed, the business intelligence server 18 may generate a project report that fully documents the completion of each task and subtask of the project as well.

In embodiments of our method, the sending of an electronic message such as a text message, electronic mail document, calendar event communication, or teleconference message or the saving of a document in a database or document storage system maintained by a server can be all that is needed for the system to identify that a task has been completed while a project is being monitored. For instance, a server that receives such a communication may be configured to send a message concerning the project being monitored to the business intelligence server 18 upon receipt of a message related to that project. Alternatively, such a message by be sent upon that device receiving a periodic request message from the business intelligence server requesting any new data related to such communication events. The business intelligence server may be configured to assess messages it receives that contains data related to such events or tasks to determine whether the task has been completed or is still being worked on.

While the project is being worked on a manager may access the business intelligence server 18 via a communication device 3 to interface with that server 18 and receive a display providing indicia indicating a degree to which that project is completed, who is or has worked on different tasks, and what tasks are left to be completed to finish the project. The user may also provide input to the business intelligence server 18 via the communication device 3 such that a project status report may be generated and printed for that project as well.

In alternative embodiments, the system may be configured so that the communication device 3 may perform the monitoring and documenting instead of a business intelligence server. For such embodiments, the communication device may be a workstation that has a sufficient network connection and hardware capacity for performing the monitoring and documenting. Of course, records made by the communication device 3 or business intelligence server 18 may be stored in memory containing a database for such records that is either local to that device or is communicatively coupled to that device.

As another example, the business intelligence server 18 may be configured to offer a choreography cockpit interface so that a graphical user interface of a communication device that communicates with the server so that the user logs on to the server to provide input to the server for creating a project, or a choreography. The user may create a unique project or may select a predefined project, or choreography. The project or choreography that is predefined may include predefined events, tasks or subtasks. Such actions may also be referred to as stage acts.

A number of the either predefined subtasks or tasks that were selected for inclusion within a project established by a user via the business intelligence server 18 may identify communication activities. Such activities may be in a predefined form, such as a phone call using a phone, exchange of email using a tablet, laptop or other computer, a conference call using a teleconference device or phone, or an instant message using a short message service. Each communication task of the project may be assigned to a particular person or employee.

For a project related to recruitment of new employees, a job application project, stage or event may be predefined. The event or stage may be an entire project or may be one stage of a multi-stage project. The responsibility for this project may be assigned to a particular human resource employee of a human resource business unit. The stage or event may not be activated as needing to be completed until receipt of another predefined task or event, such as receipt of at least one job application.

Upon receipt of a job application and recordation of the received job application by the business intelligence server 18, the job application stage may be actuated as needing to be accomplished. A warning, hint, or reminder may be sent to the person assigned to this task to prompt the person of the obtained job application as well.

The predefined stage for the “job application” may include a number of different tasks or subtasks that are included in a work list that is communicated to the human resource employee assigned to this task. Such a work list may be provided via email or may be provided via a client that runs on a computer or other communication device the employee uses that is in communication with the business intelligence server 18. The work list may include a number of tasks or subtasks shown in series that is organized in chronological order of objectives that must be accomplished, such as, for example, (1) perform structured internet research on the job application, (2) contact the proper specialized department for establishing a teleconference with team and department heads to meet and jointly review application documents; (3) send an e-mail response with general terms of employment and an invitation to an interview to application and notify the specialized department to schedule the interview; (4) contact the specialized department again using a teleconference for registering voting on hiring the application with electronic signatures; (5) withdraw the job advertisement and confirm successful hiring; (6) notify the application by telephone and provide the employment contract through a secure download; (7) start the electronic hiring workflow using human resource business software to process newly hired applicant.

When the human resource employee calls up the stage act, or job application event using a client on a communication device 3 used by the employee, the human resource employee may be provided with contact data, job advertisement and contact partners pertinent to each task or subtask. For instance, when assessing subtask (2), the contact information (e.g. telephone number and email address) for the specialized department, department heads and team members may be displayed for use in scheduling a teleconference with the identified personnel. Such contact information may be displayed with the work list, or may only be displayed after input is provided to select a particular item on the work list.

Upon learning of the “job application” stage act, the human resource employee assigned to this stage act may call up the work list via his or her communication device. Thereafter, the employee may start performing the first task by performing the internet research for the one or more job applicants that were received for a particular available position offered in a job advertisement. After performing such research and identifying viable candidates, the employee may then provide input to the business intelligence server indicating that task (1) is completed and the internet research is done. Materials found when conducting such research may also be uploaded or saved by sending data related to such materials to the business server 18 for storage by the server in either memory local to the server or a database communicatively coupled to the server. The materials may include links to web pages accessible via an internet connection, copies of scanned documents printed off from different websites, screen shots of certain webpages, or other materials.

The employee may then schedule a teleconference with team and department heads to jointly review the pertinent application documents. For instance, the employee may easily identify the pertinent contacts identified via the work list offered by the business intelligence server 18 and thereafter establish an initial conference to introduce particular applicants. For instance, the worklist displayed to the employee may show the physical location of each team member or department head, their current presence status, and their contact information pertinent to communicate with those people. During the call, the employee may provide input to the server for sending copies of the materials pertinent to the applicants to the conference participants. Additionally, or in the alternative, the employee may simply call up such documents via the client on his or her communication device for reference during the teleconference.

Thereafter the employee may schedule a video teleconference with one or more applicants. The employee may create a video conference by communicating with a teleconference server 10 and communicate the details related to the scheduled video teleconference to the application to be interviewed and others to be included in the interview such as department heads or team members. For instance, the employee may send an email containing a link that may be actuated for downloading a video client needed for running on a communication device for purposes of participating in the teleconference at the scheduled date and time.

On the day of the planned teleconference, the business intelligence server 18 may have updated its data for the “job application” project based on communications with the teleconference server or communication device of the employee so that the video teleconference was added as a subtask (2a) of task (2) for reviewing application documents. Alternatively, the new teleconference could be assigned a new number (3) and the prior numbers 3-7 could be renumbered 4-8 on the task list due to the inclusion of the new communication. A reminder may also be sent to the communication device 3 of the employee to remind the employee of the upcoming communication event.

In response to the reminder, the employee may confirm that the job applicant confirmed receipt of the email containing the link to the video client and confirmed his or her availability and intent to attend the teleconference. Such information may be provided to the business server to document that such an event occurred.

The employee may then commence the video conference. At the end of the conference, the employee thanks the applicant for attending and then terminates the teleconference connection with the applicant. The remaining teleconference attendees then discuss the applicant and determine whether an in-person interview should be scheduled.

The in-person interview may be scheduled and the business intelligence server may automatically update the work list upon its communication with other network elements to include this communication event. Alternatively, the employee may provide input to the server to include this new task in the work list.

If it is determined to offer the employee a position after the in-person interview the human resource employee may then call the applicant to offer the applicant the employment position. After that offer is accepted, the employee may then email the applicant an employment contract via email or by sending the applicant a link for downloading of the contract. The human resource employee may then also take steps to withdraw the job advertisement.

The human resource employee may subsequently provide input to the business intelligence server 18 via the communication device 3 of the employee of the completion of such tasks. Alternatively, the business intelligence server may automatically update the completion of such tasks via communications with the communication device 3, and other network elements.

The human resource person may then start using business software to start the electronic hiring workflow for processing the new employee. The business intelligence server 18 may learn of the initiation and completion of this task from input via the employee or via interactions with the server hosting this business software or communication device that is used to utilize such software.

Completion of each task and subtask, including any new subtasks or tasks added to the project is recorded and documented by the business intelligence server 18. The journal may be created that identifies the initiation and completion of each task or subtask and include copies of emails or other messages the document such occurrences or links to saved copies of such messages or documents.

Additionally, the business intelligence server 18 may save the updated choreography as an updated project or as a new predefined project that a manager can select when establishing or assigning a project to an employee. The new project or updated project incorporates the additional tasks or subtasks added by the human resource employee when performing the project. Thereafter, another project that is initiated to use the same choreography, or project, may use the same updated work list as a “best practice” work list. Alternatively, the newly added tasks or subtasks may be flagged as optional tasks for inclusion or deletion from the work list in subsequent use of the saved predefined project. A user may then delete the optional tasks if not applicable to a particular matter even though the project is similar in nature.

The business server 18 may also receive input or automatically generate key words or tags that are associated with each predefined project and stage. Such keywords and tags may be used by the server for performing searches of the predefined projects in response to received queries to identify pertinent projects responsive to such queries received from a user of a communication device. The queries may be used by a user to help the user select a predefined project or stage that the user wants to use to help the user monitor and record activities that take place during the work performed to complete a particular business activity or matter. As noted above, such predefined projects or stages may be modified or expanded with meta-information to integrate additional media or functions as well.

The server may be configured so that only predefined users that have the necessary authorization can make such deletions or modifications. Alternatively, the server may be configured to permit any employee to create a project to help aid the employee in performing different tasks and recording the efforts of the employee in completing such tasks. The employee may then be permitted to modify any predefined work list as needed to fit that employees needs.

In contrast to current workflow and process tools that are typically controlled by means of a workflow or business process execution engine, embodiments of the system may be configured so that a user and his or her communication and collaboration processes are the controlling metric of a business process and are used to define how a project is executed and completed to obtain a desired result. Embodiments of the system also permit documentation of the work that is accomplished due to the monitoring of the workflow, which may be used to help learn from past business experience so that business practices and tools used for engaging in such business may be updated and improved upon to take into account learnings from past experience. Embodiments of the system may also be configured to permit users to update the events, genres or genre subtasks so that the system is very agile and is extensible to unexpected and unplannable events that may arise as well.

It should be appreciated that embodiments of the system may be configured to realize contextual communication via interfaces with identity and access management systems in order to parameterize corporate roles or organizational information, such as reporting structures or representation rules for the persons or roles participating in the project, choreography, event, stage act, task or subtask. Alternatively, the role and the organizational knowledge can also be integrated via interfaces with business software, where this knowledge may still be administered. In addition, embodiments of the system may utilize contextual communication to its best advantage via interfaces to location-based services in order to provide local information or location-dependent information to the choreographies or stage acts.

One advantage of embodiments of the system may be to provide an integration into current and future IT landscapes based on event drive architecture. Embodiments of the system may be configured so that communication events, genres, and subtasks may be defined for utilization so that projects and project statuses may be better monitored and that the obtaining of approvals, clarifications and other information related to such communications may be monitored and also documented when such matters occur or are completed.

While certain present preferred embodiments of communication devices, systems, and apparatuses for monitoring, registering and documenting business events and otherwise processing business transactions and methods of making and using the same have been shown and described above, it is to be distinctly understood that the invention is not limited thereto but may be otherwise variously embodied and practiced within the scope of the following claims.

1. A communication system comprising:
a plurality of communication devices;
a plurality of servers communicatively coupled to the communication devices, each of the servers hosting a service accessible by the communication devices,
one of the servers or at least one of the communication devices communicating with at least one of the servers and the communication devices to monitor communication events related to a project to monitor progress of work done to complete the project, the communication events comprising at least one of Discursive Strategy Development, Clarification of Technical Details, Task Coordination, Socio-emotional Communication and Coordination of Communication, and wherein each of the communication events is comprised of at least one genre, the at least one genre comprising at least one of Situational Real-Time Planning, Ad-hoc Collaboration, Team Building, Unexpected Events, Decision Making, Management Involvement and Feedback, and Multi-channel Communication, and wherein each of the at least one genre is comprised of a plurality of subtasks needed to be completed to complete that genre, each of the subtasks requiring a use of a type of media comprising at least one of speech by phone, teleconference, application sharing, video, and instant messaging; and
wherein the one of the servers or at least one of the communication devices communicating with the at least one of the servers and the communication devices to monitor communication events related to the project receives data from the communicating such that user indicia based on the data is displayable that identifies a degree to which the project is completed upon receipt of user input for assessing the project, the progress of the project estimating a degree to which at least one of (i) the communication events, (ii) the at least one genre, and (iii) the subtasks is completed.

2. The system of claim 1 wherein one of the servers communicates with the at least one of the servers and the communication devices to monitor communication events related to the project.

3. (canceled)

4. The system of claim 1 wherein users are assigned to the project, each of the users being assigned a respective role for assisting in completion of the project, communication with the at least one of the servers and the communication devices to monitor the communication events related to the project to update data related to changes in a degree to which the project is completed, and wherein at least one of corporate roles and organization information for the users is communicated for identifying how the users are to be assigned to the roles for the project and wherein the communication devices that are communicated with for monitoring the project comprise communication devices associated with the users assigned to the project.

5. The system of claim 3 wherein the servers comprise a messaging server, a presence server and electronic mail server and a context server.

6. The system of claim 1 wherein each of the communication devices is one of a computer, a laptop, a tablet, a workstation, and a cellular phone.

7. The system of claim 1 further comprising at least one gateway communicatively coupling the communication devices to a network, the servers being communicatively coupled to the communication devices via the network.

8. The system of claim 1 wherein at least one of the communication devices communicates with at least one of the servers and the communication devices to monitor the communication events related to the project.

9. The system of claim 1 wherein the project is monitored such that messages are periodically sent to the at least one of the servers and the communication devices to prompt receipt of data related to completion of the project.

10. The system of claim 1 wherein the data related to completion of the project comprises data for displaying a link for obtaining a view or copy of documents generated for completion of (i) one of the communication events, (ii) one of the at least one genre, and (iii) one of the subtasks, the link being configured so that upon actuation of the link an approval document is at least one of downloaded and viewable from one of the communication devices or other device used to access that link via communication with the device that has the memory in which the generated document is stored.

11. A method for monitoring work on at least one project comprising:
selecting at least one communication event from the group consisting of Discursive Strategy Development, Clarification of Technical Details, Task Coordination, Socio-emotional Communication and Coordination of Communication, to include into a first project of the at least one project for completing the first project, for each of the selected at least one communication event, users being assigned to that event, each of the assigned users being assigned a role for assisting in completion of the first project;
selecting at least one genre from the group consisting of: Situational Real-Time Planning, Ad-hoc Collaboration, Team Building, Unexpected Events, Decision Making, Management Involvement and Feedback, and Multi-channel Communication, the selecting of each of the at least one genre being selected to correspond with one of the selected at least one communication event, each of the at least one genre including a plurality of subtasks needed to be completed to complete that genre, the subtasks requiring a use of a type of media comprising at least one of speech by phone, teleconference, application sharing, video, and instant messaging;
a plurality of communication devices communicating with a plurality of servers, each server hosting at least one service accessible to the communication devices;
one of the servers or at least one of the communication devices monitoring work done to complete the first project by communicating with at least one of the servers and at least some of the communication devices to monitor the work done to complete the first project, wherein a progress of the at least one communication event, the at least one genre, and the subtasks for the first project is monitored; and
the one of the servers or at least one of the communication devices providing data such that user indicia based on the data is displayable that identifies a degree to which the first project is completed upon receipt of user input for assessing the first project, wherein a progress of the at least one communication event, the at least one genre, and the subtasks is estimated.

12. The method of claim 11 wherein messages are periodically sent to the at least one of the servers and the communication devices to prompt receipt of data related to completion of the first project.

13. The method of claim 11 wherein the user indicia also comprises data such that indicia identifying the users associated with the first project are also displayable.

14. The method of claim 13 further comprising updating data related to the first project to account for changes in progress related to the at least one communication event associated with the first project such that the updated data is providable for inclusion in the data provided such that user indicia based on the data is displayable that identifies a degree to which the first project is completed upon receipt of user input for assessing the project.

15. The method of claim 14 further comprising updating data related to the first project to account for changes in progress related to the at least one genre and the subtasks associated with the at least one genre such that the updated data is providable for inclusion in the data provided such that user indicia based on the data is displayable that identifies a degree to which the first project is completed upon receipt of user input for assessing the first project.

16. The method of claim 11 wherein each communication event has a plurality of tasks associated with that event that are included in a work list that lists the tasks in series that is organized in chronological order to identify which of the tasks must be accomplished prior to other ones of the tasks.

17. The method of claim 11 further comprising integrating situational business process fragments of a preexisting IT system with the genres for monitoring and recording speech of the users assigned to first project to integrate into execution of at least partially defined routine processes used for completing one of the subtasks when prerequisites for working on that subtask have been met.

18. The method of claim 11 further comprising parameterizing corporate roles or organizational information for the users via contextual communication with identity and access management systems.

19. The method of claim 18 further comprising utilizing contextual communication via interfaces to location-based services in order to provide local information or location-dependent information for monitoring of progress relating to the first project, the at least one communication event, the at least one genre, or at least one of the subtasks.

20. The method of claim 11 wherein the data related to completion of the first project comprises data for use in displaying a link for obtaining a view or copy of documents generated for completion of one of the (a) at least one communication event, (b), at least one genre, and (c) the subtasks, the link being configured so that upon actuation of the link an approval document is at least one of downloaded and viewable from a communication device or other device used to access that link via communication with the device that has the memory in which the generated document is stored.

21. The method of claim 11 wherein role of the users and the organizational knowledge of the users is integrated via interfaces with business software running on different devices, the role of the users and the organizational knowledge being administered.

22-32. (canceled)
